(19) United States
(12) Patent Application Publication
(10) Pub. No.: US 2005/0053903 A1
(43) Pub. Date: Mar. 10, 2005

(54) Method for aligning instruction and content to increase learning

(76) Inventor: Sandra Darling, Chandler, AZ (US)

Correspondence Address: JOSEPH W MOTT;JENNINGS STROUSS & SALMON PLC, 201 EAST WASHINGTON STREET, 11TH FLOOR, PHOENIX, AZ, 85004-2385, US

(21) Appl. No.: 10/660,282

(22) Filed: Sep. 10, 2003

(51) Int. Cl. G09B 19/00

(52) U.S. Cl. 434/236

(57) ABSTRACT

A method of improving learning by aligning instructional strategies to knowledge to be learned. The method involves identifying particular items of knowledge to be learned, classifying the items by knowledge domain implicated in each item, classifying the items by brain processing function used to learn each item, and selecting instructional strategies that address the knowledge domain and the brain processing function associated with each item.

### TECHNICAL FIELD

The technical field is education. The invention relates to a unique process of alignment between instruction and content that will produce an increase in learning, measurable by a specific number of percentile points based on documented research generating Effect Size data for the adopted instructional strategy.

### BACKGROUND OF THE INVENTION

Learning is a change or increase in knowledge acquisition. There are three domains of knowledge which can be measured by multiple measures: declarative knowledge, procedural knowledge, and psychomotor knowledge (Marzano, 1998). Two of those domains of knowledge are addressed in virtually all instructional/learning situations (e.g., business, schools, vocational training, universities, etc.): declarative and procedural knowledge. To increase knowledge acquisition, or learning of declarative and procedural knowledge, there are 3 keys processes that must be aligned to measurably improve learning (Wiggins, 1997, 1998; Taylor, 1997; Stiggins, 1994; Lezotte, 1987; Snyder, 1987; Edmonds, 1982; Purkey & Smith, 1983; Carlson & Ducharme, 1987; Good & Brophy, 1986; Joyce & Weil, 1996; Slavin, 1987). Those three key processes are: 1) adoption of standards and/or curriculum (the explicit content to be learned in the declarative and procedural knowledge domains), 2) assessment (the measures of how well the standards and/or curriculum were learned), and 3) instruction (the application of instructional strategies to explicit content from the declarative and procedural knowledge domains). Traditional alignment processes utilized in delivery of learning typically map content to content. Examples of this include the alignment of district developed curriculum (content) with state developed content standards. Textbooks (containing content to be learned) are aligned with district developed curriculum (content) and with state developed content standards. Commercially available content (e.g., Pearson's Model Curriculum and Assessment Database —MCAD) is aligned with state developed content standards and textbooks. Some companies, such as Align to Achieve, have databases that align content to content for education. Content from the Mid-continent Research on Education and Learning (McREL) Compendium of Standards is aligned to state content standards.

The alignment of instructional strategies to content has never been done in any systematic way. Instruction is applied to content in education, business, and higher education based on past practice, without specific criteria for its application. Instructors and trainers have no knowledge of how much difference in learning a particular instructional strategy will make with specific content.

There is an emerging body of knowledge on how the brain learns, (e.g., Eric Jensen, Teaching with the Brain in Mind (1998); Patricia Wolfe, Brain Matters: Translating Research into Classroom Practice (2001); Robert Sylwester, A Celebration of Neurons: An Educator's Guide to the Human Brain (1995); Geoffrey and Renate Caine, Mindshifts (1994); Susan Greenfield, The Human Brain: A Guided Tour (1997); J. LeDoux, Emotion, Memory, and The Brain (1994); Marilee Sprenger, Learning & Memory: The Brain in Action (1999), etc.) but no systematic approach to instruction or training based on how the brain learns specific content. Alignment of assessment to measure knowledge acquisition of content has been done by many companies, universities, and training organizations (e.g., NCS Pearson, McGraw Hill, Psychological Corporation, Stanford University, College Board). No alignment process has been established, nor alignment done, for aligning training procedures or research-based instructional strategies to the declarative and procedural knowledge domains of content utilizing specific criteria such that learning (knowledge acquisition) can be predicted to increase.

### SUMMARY OF THE INVENTION

This invention is a process of alignment between a) documented and established instructional strategies and/or training procedures and b) both the knowledge domain of content and the system of thinking implicated in learning the content. Content to be learned is classified by objective criteria into its appropriate knowledge domain. The same content is separately classified according to the brain processing function used to learn the content. The universe of available instructional strategies is then mapped to the content, with strategies that address the wrong knowledge domain or the wrong brain processing function discarded. Other known characteristics of the instructional strategies may then be used to rank the strategies that align properly to the content.

The claimed alignment process has been applied to State Academic Content Standards and Benchmarks, promulgated by each state in the U.S., to develop a database of effective teaching strategies aligned to the benchmarks.

### BRIEF DESCRIPTION OF DRAWINGS

FIG. 1 is the set of Mathematics Standards promulgated by the Mid-Continent Research for Education and Learning organization (McREL).

FIG. 2 is a partial set of McREL benchmarks, for grades K-8, associated with Mathematics Standard No. 8.

FIG. 3 presents a classification test for determining the knowledge domain of individual state educational standards.

FIG. 4 shows examples of state standard benchmarks that represent declarative knowledge.

FIG. 5 shows examples of state standard benchmarks that represent procedural knowledge.

FIG. 6 shows a test for classifying standards benchmarks according to systems of thinking applied.

FIG. 7 shows examples of benchmarks addressed by the Self System.

FIG. 8 shows examples of benchmarks addressed by the Metacognitive System.

FIG. 9 shows examples of benchmarks addressed by the Storage and Retrieval function of the Cognitive System.

FIG. 10 shows examples of benchmarks addressed by the Informative Processing function of the Cognitive System.

FIG. 11 shows examples of benchmarks addressed by the Input/Output function of the Cognitive System.

FIG. 12 shows examples of benchmarks addressed by the Knowledge Utilization function of the Cognitive System.

FIG. 13 shows possible education strategies analyzed with respect to a specific Language Arts benchmark and rejected as not properly aligned.

FIG. 14 shows the set of possible education strategies that are aligned to the specific Language Arts benchmark addressed in FIG. 13.

### DETAILED DESCRIPTION

Over the past forty years, many thousands of studies have examined the impact of a large array of teaching methods, techniques and strategies on the acquisition of knowledge. Pioneering work in meta-analysis of the studies and published data by William Glass and his colleagues in the late 1970's resulted in the adoption of a standardized metric known as Effect Size to quantify the impact on learning exhibited by the technique, procedure or approach under study. Since that time, a significant percentage of education-related studies has reported Effect Size along with other measures of success or failure.

Work done by Robert Marzano and others around the turn of the century has shown that the Effect Size of an instructional strategy upon the content will vary depending upon the strategy that is being used to teach. In particular, the Effect Size for a strategy tends to hold when the content being taught is characterized by the same knowledge domain as the instructional strategy (R. Marzano and J. Kendall, A Comprehensive Guide to Designing Standards-Based Districts, Schools and Classrooms, ACSD, 1996, Chap. 8) and implicates the same brain processing function (R. Marzano, A theory-based Meta-analysis of Research on Instruction, McRel, 1998). The Effect Size decreases, or does not hold at all, where the instructional strategy does not align with the knowledge domain and brain processing that characterizes what is to be learned.

Knowledge Domains

Knowledge has been classified in many ways. Benjamin Bloom created a hierarchy called Bloom's Taxonomy that classified knowledge based on its level of thinking complexity. Robert Marzano in A Theory Based Meta-analysis of Research on Instruction (1998) described knowledge as comprised of information, mental processes, and psychomotor processes that are specific to a given subject matter. For example, the knowledge specific to the subject of geography includes information about various locations, weather patterns, and the influences that location has on the development of a region; the knowledge associated with geography also includes mental processes such as how to read and utilize a contour map, how to read and utilize a political map, and so on. There is probably little, if any, psychomotor knowledge that is specific to geography. Flying, on the other hand, has a significant amount of psychomotor knowledge. For example, a pilot must master the physical skills involved in landing, taking off, etc. Informational knowledge necessary to be an effective pilot would include an understanding of certain key concepts such as lift and drag. Finally, the mental process knowledge necessary to be an effective pilot would include strategies for efficient scanning and interpretation of an instrument panel. Marzano concludes that “given the inherent differences in these types of knowledge, it is useful to think of them as related domains of knowledge.” Marzano, et.al. in A Different Kind of Classroom: Teaching with Dimensions of Thinking, (1992) describes the two types of knowledge that students acquire: declarative and procedural, in Dimension Two: Acquire and Integrate Knowledge. This resource provides information on the distinguishing characteristics of declarative and procedural knowledge. Marzano and Kendal in A Comprehensive Guide to Designing Standards Based Districts, Schools, and Classrooms (1996) define and delineate the categories of both declarative and procedural knowledge. Marzano and Kendall in Content Knowledge. A compendium of standards and benchmarks for K-12 education (3rd ed.) (2000) describe standards as containing declarative or procedural knowledge. Based on these definitions, McREL (Mid-Continent Research on Education and Learning) has helped over 30 states with the development of their content standards to reflect content knowledge in the language of declarative and procedural knowledge.

Declarative Knowledge

Declarative knowledge consists of information that is hierarchic in nature by levels of specificity. The most basic declarative knowledge is vocabulary, and the most general is as concepts. Described by Robert Marzano and John Kendall in A Comprehensive Guide to Designing Standards-Based Districts, Schools, and Classrooms, ASCD, 1996, Chapter 8, declarative knowledge is information or what we want learners to know as a result of instructional applications. The levels of information included in the hierarchy of declarative knowledge are: Vocabulary Terms—Knowing a vocabulary term means understanding the meaning of a word at a very general level. The learner has a general idea what the word means and no serious misconceptions about its meaning. A learner has accurate, but somewhat surface-level, understanding of the meaning of the terms.

Facts—Facts are a very specific type of declarative knowledge that convey information about specific persons, places, living and nonliving things, and events. They commonly articulate information such as the following:
a. The characteristics of a specific person
b. The characteristics of a specific place
c. The characteristics of specific living or nonliving things
d. The characteristics of a specific event

Time Sequences—Time sequences include important events that occurred between two points in time. For example, the events that occurred between President Kennedy's assassination on Nov. 22, 1963, and his burial on Nov. 25, 1963, are organized as a time sequence.

Cause/Effect Sequences—Cause/effect sequences involve events that produce a product or and effect. A causal sequence can be a simple as a single cause for a single effect. For example, the fact that the game was lost because the football player dropped the ball in the end zone can be organized as a causal sequence. More commonly, however, effects have complex networks of causes; one event affects another that combines with a third event and so on.

Episodes—Episodes are specific events that have (1) a setting (e.g., a particular time and place), (2) specific participants, (3) a particular duration, (4) a specific sequence of events, and (5) a particular cause and effect. For example, the events of Watergate could be organized as an episode.

Generalizations—These are statements for which examples can be provided. For example, the statement, “U.S. presidents often come from families that have great wealth or influence” is a generalization, for which examples can be provided. It is easy to confuse some generalizations with some facts. Facts identify characteristics of specific persons, places, living and nonliving things, and events, whereas generalizations identify characteristics about classes or categories of persons, places, living and nonliving things, and events. Information about abstractions is always states in the form of generalizations.

Principles—Principals are specific types of generalizations that deal with relationships. In general, there are two types of principles found in school-related declarative knowledge: cause/effect principles and correlational principles.
a. Cause/effect principles articulate causal relationships. For example, the sentence, “Tuberculosis is caused by the tubercle bacillus” is a cause/effect principle. Understanding a cause/effect principle includes knowledge of the specific elements within the cause/effect system and the exact relationships those elements have to one another.
b. Correlational principles describe relationships that are not necessarily causal in nature, but in which a change in one factor is associated with a change in another factor. For example, the following is a correlational principle: “The increase in lung cancer among women is directly proportional to the increase in the number of women who smoke.”

These two types of principles are sometimes confused with cause/effect sequences. A cause/effect sequence applies to a specific situation, whereas a principle applies to many situations. The key distinction between principles and cause/effect sequences is that principles can be exemplified in a number of situations, whereas cause/effect sequences cannot—they apply to a single situation only.

Concepts—Concepts are the most general way of thinking about knowledge in that virtually all ways of thinking about knowledge can be subsumed under them. That is, a concept can be the general category under which fall a number of principles and generalizations, a time sequence, a cause/effect sequence, an episode, and a number of vocabulary terms. Concepts are commonly represented by a single word or a phrase. They function as an organizer for all of the other types of declarative knowledge. One noteworthy difference between concepts and vocabulary terms is that all words can be addresses as vocabulary terms, but not all words can be addressed as concepts. Only those words that represent broad categories of information qualify as concepts.

Procedural Knowledge

Defined by Robert Marzano and John Kendall in A Comprehensive Guide to Designing Standards-Based Districts, Schools, and Classrooms, ASCD, 1996, Chapter 8, procedural knowledge consists of a hierarchy of processes and skills, or what we want the learner to be able to do as a result of instructional applications. The various levels of procedural knowledge are algorithms, strategies, and macroprocesses.

Algorithms—Algorithms are the most specific type of procedural knowledge. They are usually comprised of steps that are performed in a fairly strict order. For example, when you divide one number into another, you are performing an algorithm, the steps of which must be performed in a set order. An important feature of algorithms is that to be effective they should be performed without much conscious effort.

Strategies—Strategies commonly involve the application of basic rules. However, these rules are not necessarily applied in any specific order. The task can be accomplished in a wide variety of ways. For example, when you read a graph, there are some steps involved, such as reading the title of the graph, identifying what is reported on one axis, identifying what is reported in the other axes, and so on. However, there is no set order in which the steps must be performed. Additionally, strategies are not performed as automatically as algorithms. They take some thought to determine the best rule to be applied at any given time. Examples of process that involve strategies include reading a chart or graph; editing an essay for logic, diction, or mechanics; and analyzing a presentation for errors.

Macroprocesses—Macroprocesses are the most general type of procedural knowledge. They are “big” processes with many interactive components. For example, the macroprocess of reading is comprised of five interactive components:
a. The general task processor
b. The information screener
c. The idea network processor
d. The word processor
e. The macrostructure generator

Each of these components represents separate lines of cognitive processing, which commonly occur simultaneously. Examples of macroprocesses include reading for comprehension, driving a car, problem solving in various situations, and giving a speech.

Systems of Thinking

The Systems of Thinking were defined in A Theory-based Meta-analysis of Research on Instruction by Robert Marzano (McREL, 1998). The meta-analysis described the interaction of four aspects of human thought: 1) knowledge (three domains: declarative, procedural, and psychomotor), 2) the cognitive system, 3) the metacognitive system, and 4) the self-system. Self-system—The self-system contains a network of interrelated beliefs that enable one to make sense of the world. It contains processes that evaluate the importance of the presenting learning task relative to a system of goals, and assesses the probability of success relative to the individual's beliefs (Garcia & Pintrich, 1995). If the presenting task is judged as important and the probability of success is high, positive affect is generated and the individual is motivated to engage in the presenting task (Ajzen, 1985; Ajzen & Fishbein, 1977, 1980; Ajzen & Madden, 1986). If the presenting task is evaluated as low relevance and/or low probability of success, negative affect is generated and motivation for task engagement is low. The learner may choose compensatory activities or to maintain the status quo. Because the mechanisms in the self-system are working elements that define motivation and volition in human behavior, they are historically been referred to as “conative” structures (Snow & Jackson, 1993) where conation is defined as “the part of mental life having to do with striving, including desire and volition” (Flexner and Houck, 1987, p. 422).

Metacognitive System—Regardless of whether the presenting task or compensatory activities are selected, the metacognitive system is engaged. The metacognitive system contains information about the nature and importance of plans, time lines, resources and their interactions (Schank & Abelson, 1977). This system is responsible for designing strategies for accomplishing a given goal once it has been set (Sternberg, 1986). The metacognitive system is continually interacting with the cognitive system throughout the task.

Cognitive System—The cognitive system is responsible for the effective processing of the information that is essential to the presenting task. For example, if the presenting task requires solving a problem, the cognitive system is responsible for the effective execution of the steps involved in problem solving. The processes within the cognitive system act on an individual's knowledge base (Anderson, 1995; Lindsay & Norman, 1977). There are four (4) categories of brain processing functions within the cognitive system: (1) storage and retrieval, (2) information processing function, (3) input/output function, and (4) knowledge utilization.

Knowledge Domains—Relative to any given presenting learning task, knowledge is the information and skills that is specific to the task. There are three (3) knowledge domains—Declarative Knowledge, Procedural Knowledge, and Psychomotor Knowledge. In order to acquire knowledge (procedural, declarative, psychomotor), three innate brain processors are engaged to embed new knowledge into memory: They are representational modalities or “modes” that are the building blocks of the three systems and knowledge. They are: (1) the linguistic processor or mode, (2) the nonlinguistic processor or mode, and (3) the affective mode. The data in the cognitive system, the metacognitive system, self-system, and knowledge are made up of structures that contain linguistic, nonlinguistic, and affective components.

All learning proceeds from the self-system, to the metacognitive system, to the cognitive system which acts upon the knowledge domains (Marzano, 1998). The brain processors are engaged to embed the data of the systems into memory. Processing functions were identified, with their accompanying impact on learning (Effect Size) for each of the knowledge domains. Instructional or training strategies were identified within each processing function of the self-system, the metacognitive and cognitive system (and their underlying functions).

Impact on Learning

One of the significant findings of Marzano's meta-analysis was that the impact on learning or knowledge acquisition (Effect Size) achieved with an instructional or training strategy changed, depending on (1) the knowledge domain to which it was applied and (2) the type of brain processing that was needed for it to be embedded into memory. For example, Concept Attainment (an information processing instructional strategy) has an Effect Size of ES=1.32 (a superior impact on learning) when used to identify defining characteristics of concepts and the rules for inclusion/exclusion into a concept category (declarative knowledge and requiring an information processing function of the cognitive system). However, when Concept Attainment is utilized to acquire procedural knowledge, it has a low impact on learning (ES=0.10). Concept Attainment results in little or no knowledge acquisition when used to engage the functions of the self-system or metacognitive system.

Applying the Alignment Process

Two sets of data, obtained external to the claimed process, are used as starting point for alignment. The first of these is the content and the second is the array or set of instructional strategies available to teach the content.

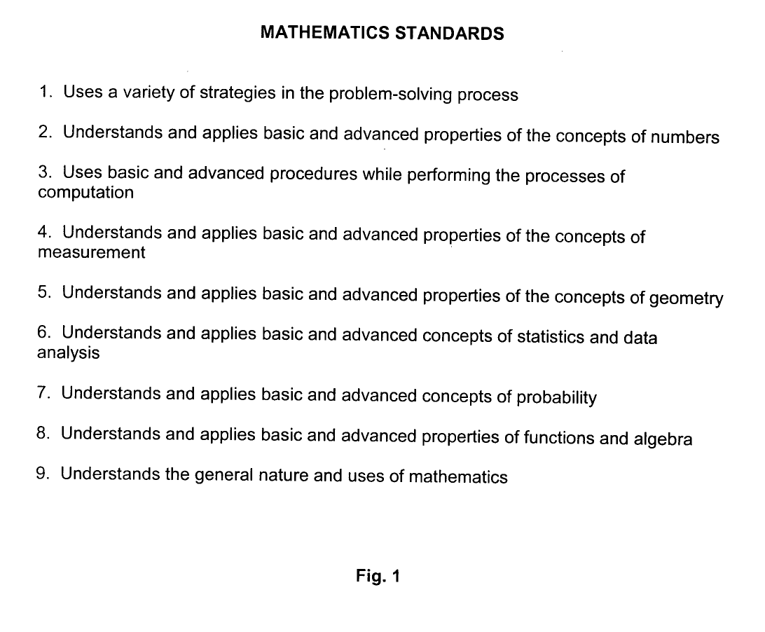

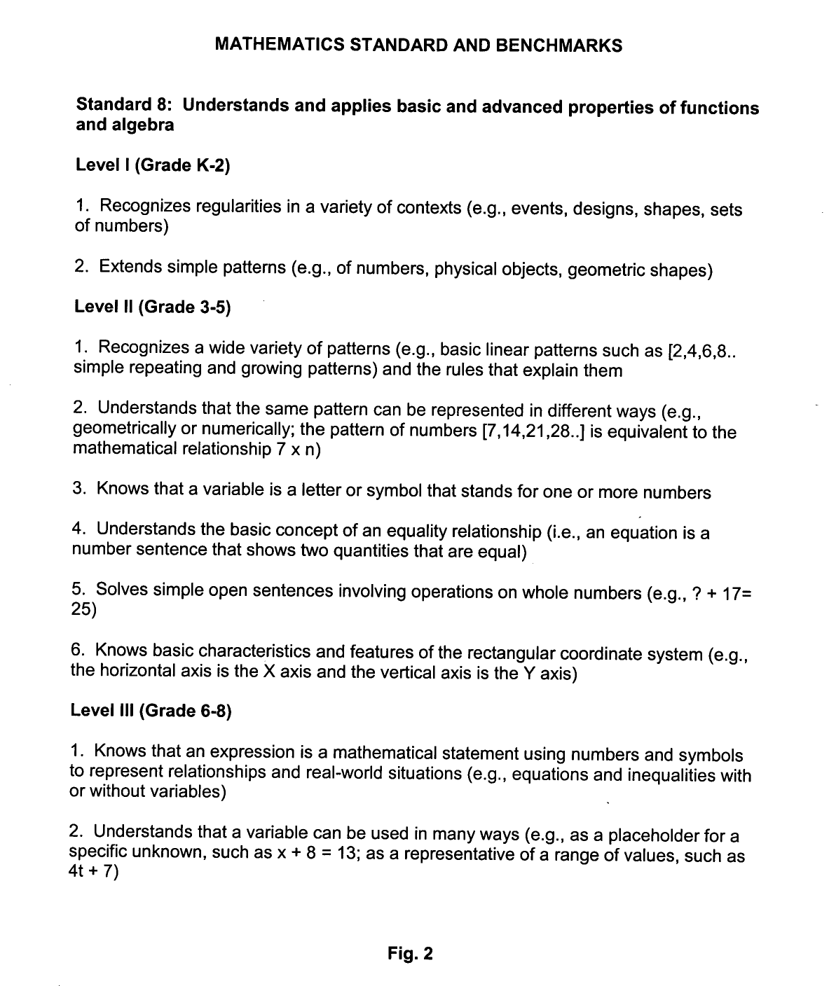

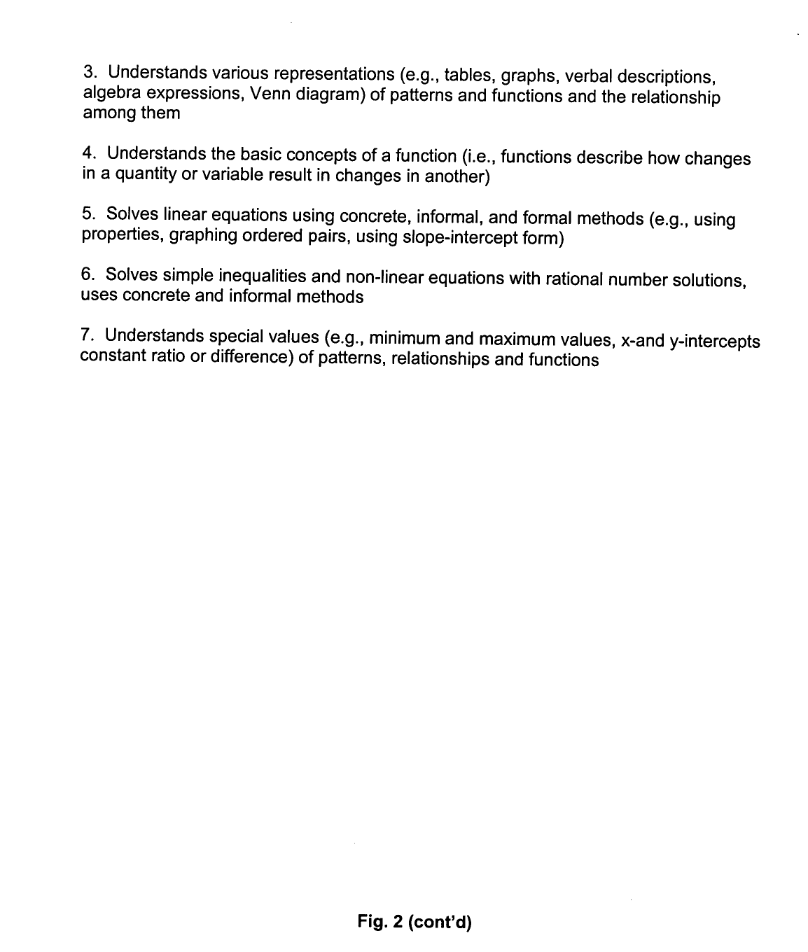

Content is the knowledge—procedural knowledge, declarative knowledge, or both—that is to be learned. Often stated in terms of learner outcomes, or objectives, that state what the learner will know, or be able to do, as a result of an instructional intervention. Content is the information and processes/skills that are expected to be acquired and embedded into memory in order to say that learning has occurred. In the public education system, the content to be taught is often expressed as a grade-appropriate set of benchmarks associated with subject standards in, for example, mathematics or language arts. An example of a set of standards for mathematics is shown in FIG. 1 and the associated benchmarks are shown in FIG. 2.

Instructional strategies are the approach, or intervention, a teacher may take to achieve learning objectives. Strategies can be classified (based on the degree of teacher directed vs. learner directed) as direct, indirect, interactive, experiential, or independent. Instructional strategies are used by teachers to create learning environments and to specify the nature of the activity in which the teacher and learner will be involved during the lesson. Joyce & Weil divide instructional strategies into four models: Information processing, personal, social interaction, and behavioral based on the type of interaction between learner and teacher. Decision making regarding instructional strategies requires teachers to focus on curriculum, the prior experiences and knowledge of students, learner interests, student learning styles, and the developmental levels of the learner. Such decision making relies on ongoing student assessment that is linked to learning objectives and processes.

The claimed process was used to map a database that identified the state content standards and grade level benchmarks for mathematics and language arts from 49 states against a database of thousands of discrete instructional strategies extracted from tens of thousands of educational studies. The strategies were included in the database if they were reported as a statistically significant, controlled study in a recognized, peer reviewed source and indicated the effect size of the strategy. The claimed process may, of course, be used with a less rigorously developed universe of instructional strategies, depending upon what is available, and may be aligned to content requirements presented in a form other than grade level benchmarks.

Prior to conducting alignment, 60 hours of training of the development team was provided on Effect Size research, standards, benchmarks, content identifiers, brain research, brain processing, Marzano's meta-analysis of research on instruction, Joyce & Weil's instructional framework, multiple intelligences, and criteria for a review of the literature and research. Identification and selection of effective instruction strategies from the research and relevant literature was based on the following criteria:
Effect Size=0.40 or greater
Statistically significant n used in the research
Paired studies with control and experimental groups
Peer reviewed
Replicable
Acceptable sources: primary source research, research reports, books, research articles, meta-analyses, dissertations, journal articles.

Through a review of tens of thousands of studies, including meta-analyses of research, the Effect Size was obtained for instructional models, instructional strategies, instructional methods, and instructional skills. These characterized instructional strategies became the inventory of available strategies to be aligned to the designated content. As noted, the published state-by-state grade-appropriate subject standards and benchmarks, known to the educational community, were used as the content to which strategies would be aligned.

Determining Knowledge Domain of Content Standards

As noted previously, declarative knowledge consists of information that is hierarchic in nature by levels of specificity, and can be recognized by educators from an analysis of a particular item of content or standard.

It is information which has component parts. It is a fact or detail that conveys information about specific persons, places, living and nonliving things, and events that contain characteristics. It is vocabulary terms. It is a cause/effect sequence that involves events that produce a product or an effect. It is a time sequence that includes important events that occurred between two points in time. It is an episode with a) a setting, 2) specific participants, 3) a particular duration, 4) a specific sequence of events, 5) a particular cause and effect. It is a generalization or statement for which examples can be provided. It is a principle or specific type of generalization that deals with relationship, such as cause/effect principles and correlational principles. It is a concept or general category under which fall a number of principles and generalizations, time sequences, cause/effect sequences, episodes, and a number of vocabulary words (usually represented by a single word or phrase) that function as organizers for other types of declarative knowledge.

The performance of declarative knowledge at various levels is assessed by addressing the extent to which examples are provided, relationships and distinctions are articulated, and misconceptions are avoided. It is often written into standards as, “The student will KNOW” or “The student will UNDERSTAND” followed by the specific declarative knowledge.

Procedural knowledge consists of a hierarchy of processes and skills, or what we want the learner to be able to do as a result of instructional applications. It is a process or skill that requires a performance. It is a single rule or a small set of rules with no accompanying steps such as one if/then production. It is an algorithm that is comprised of steps that are performed in a fairly strict order without much conscious effort. It is a strategy that involves the application of basic rules, however, not necessarily applied in any specific order and with conscious thought to determine the best rule to be applied at a give time. It is a macroprocess that contains many interactive components to demonstrate.

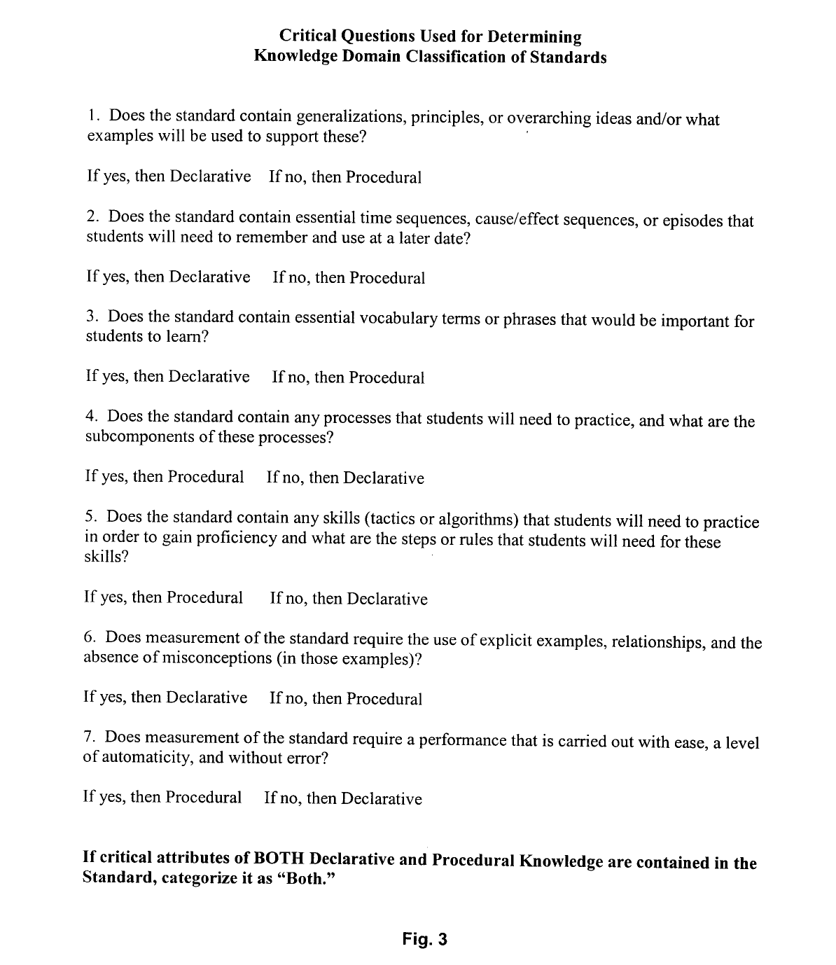

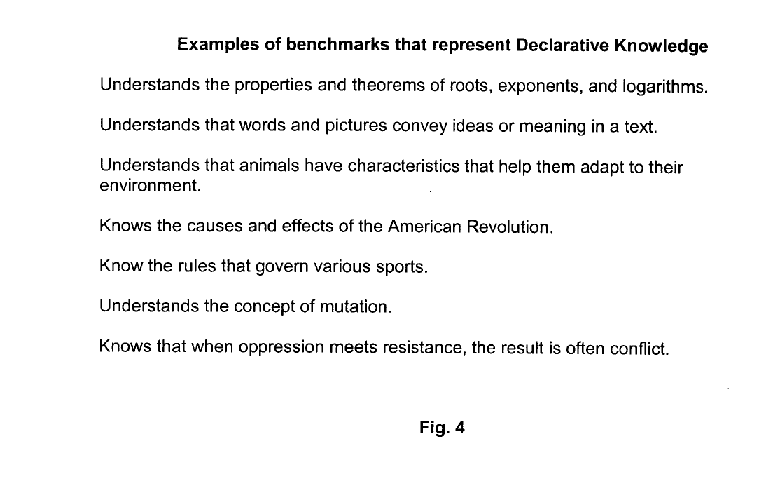

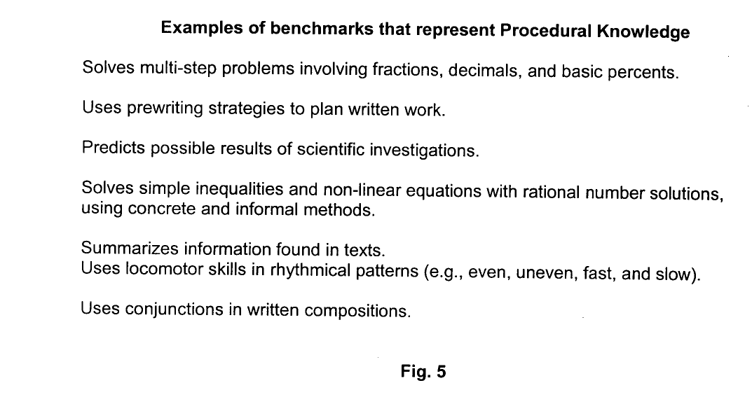

The performance of procedural knowledge is measured by the degree of ease and automaticity with which skills and processes are carried out without significant error. It is often written into standards with an action verb requiring a performance (e.g., students must do some action). Classification of educational standards or benchmarks (content) into the proper knowledge domain may be accomplished systematically through a series of questions or tests directed at the content. FIG. 3 shows the classification test used by the inventor in connection with classifying the state instructional standards. FIGS. 4 and 5 depict state benchmark items taken from a variety of different subject areas, that represent declarative and procedural knowledge, respectively.

Determining Systems of Thinking for Content Standards

Critical Attributes of Self-System

The Self-System is the first system that is engaged by the brain when a given task is presented. This system is defined by an interrelated system of beliefs and processes that determines whether an individual will engage in or disengage in a given task and what is attended to from moment to moment. The Self-System contains 5 categories of beliefs about 1) self-attributes, 2) self and others, 3) the nature of the world, 4) efficacy, and 5 purpose. It is the brain processing of the Self-System that dictates motivation and attention when a student is presented with a learning task. All learning originates in the Self-System as the learner decides to engage or not based on the 5 categories of beliefs and a control mechanism that impacts motivation and attention. Brain processing of the Self-system is encoded into the brain by all three representational modalities (linguistic, nonlinguistic, and affective). Instructional strategies that engage the Self-System address issues such as relevancy, attention, and motivation, and beliefs about self and others. Other effective instructional strategies often incorporate the engagement of the Self-System as the first part of their procedure because of its impact on learning.

Critical Attributes of the Metacognitive System

The Metacognitive System is the system of thinking that is responsible for organizing, monitoring, evaluating, and regulating the functioning of all other types of thought. It contains 4 categories of components: 1) goal specification, 2) process specification, 3) process monitoring, and 4) disposition monitoring.

The Goal Specification category of the Metacognitive System is engaged or activated when the general goal of engaging in the presenting learning task (from the Self-system) is received and goal setting is required to assure that the tasks occurs.

It is Process Specification of the Metacognitive System to identify or activate retrieval of specific skills, tactics, and processes that will be used in accomplishing the goal and the order in which they will be executed.

Process Monitoring of the Metacognitive System is required to monitor the effectiveness of the actual algorithms, tactics, and processes that are being used in the task. Process Monitoring makes decisions as to the use and timing of processes and resources to accomplish a learning task.

It is Disposition Monitoring of the Metacognitive System that addresses the extent to which the learning task is carried out in ways that optimize the effectiveness of the algorithms, tactics, and processes being utilized, or how one approaches the task that has been selected-how one is “disposed” to the task. Dispositions to be monitored by the Disposition Monitoring of the Metacognitive System are: accuracy and precision, clarity, restraint or impulsivity, intensity of task agreement, and task focus.

The Metacognitive System is comprised of pure procedural structures with no nonlinguistic or affective modalities for encoding into the brain. Instructional strategies that address the Metacognitive System are those addressing goal setting, monitoring our use of strategies as to their effectiveness (e.g., those that address self-monitoring and self-correcting strategies for reading comprehension), and choosing learning strategies, monitoring their effectiveness and making adjustments in strategy choice based on that monitoring.

Critical Attributes of the Cognitive System

The Cognitive System of Thinking is the system of mental processes, organized into 4 categories: 1) storage and retrieval, 2) information processing, 3) input/output, and 4) knowledge utilization, that act on knowledge in the Knowledge Domains.

The Storage and Retrieval of the Cognitive System provides an individual with access to knowledge stored in permanent memory and a way of storing new knowledge so that it might be used at a later date.

Information Processing of the Cognitive system manipulates knowledge that has been stored so that it might be used for specific tasks. There are six basic information processing functions in brain processing: 1) matching, 2) idea representation 3) information screening 4) generalizing, 5) specifying, and 6) data production.

Matching processes address the identification of similarities and differences for the elements in working memory.

Idea representation is the process of translating the data in working memory into a form suitable for storage in permanent memory and contains constructed representations that are interpretations of sensory data for the processors (linguistic, nonlinguistic, affective). The idea representation function coordinates the activity of the linguistic, nonlinguistic, and affective processors of the brain.

Information screening functions address the logic or reasonableness of data that has been represented in working memory. It screens new knowledge to determine if it makes sense relative to what the student already knows about the topic.

Information generalization functions generate inferences (inductive in nature) about specific information in working memory regarding their relationships to more general structures. Information specification functions are deductive in nature made with two types of rules: synchronic and diachronic. Synchronic rules (categorical and associative) are a temporal and form the basis for classification and categorization. Diachronic rules deal with basic relationships of cause/effect and temporal order (predictor and effector).

Idea production functions generate new propositions using information from permanent memory to construct new knowledge.

The Input/Output of the Cognitive System is uses knowledge to understand communication and generate communication. This component of the Cognitive System addresses transactions with the outside world (as opposed to the other information processing functions that deal primarily with immediate data in working memory). All of these processes utilize the storage/retrieval processes as well as the information processing functions. They are responsible for decoding language from the outside world and encoding thoughts generated working memory into a form suitable for communication. Input communication processes are reading and listening. Output communication processes are speaking and writing.

Knowledge Utilization of the Cognitive System uses knowledge to accomplish specific tasks. There are four knowledge utilization processes: 1) decision-making 2) problem solving 3) experimental inquiry, and 4) investigation. Decision-making is utilized when an individual must select between two or more alternatives. Problem solving is utilized when an individual is attempting to accomplish a goal for which an obstacle exists. Experimental inquiry involves generating and testing hypotheses for the purpose of understanding some physical or psychological phenomenon. Investigation is the process of generating and testing hypotheses about past, present, or future events. It differs from experimental inquiry in that it utilizes different “rules of evidence.” The rules of evidence adhere to the criteria for sound argumentation whereas the “rules of evidence” for experimental inquiry adhere to the criteria for statistical hypotheses testing.

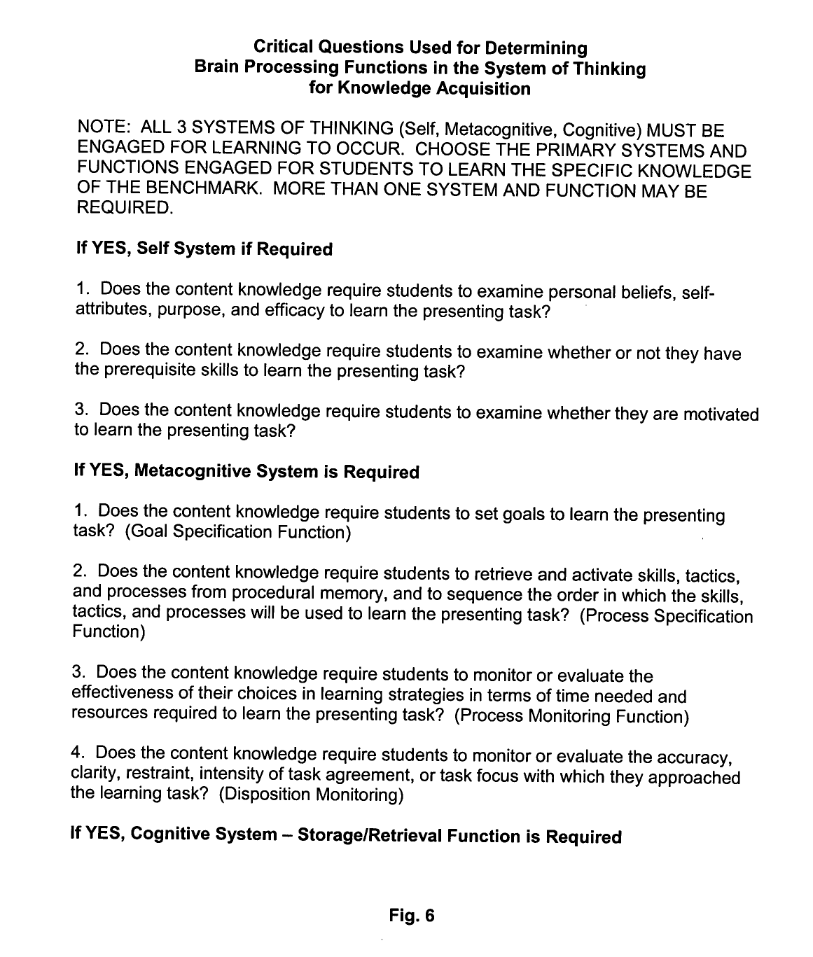

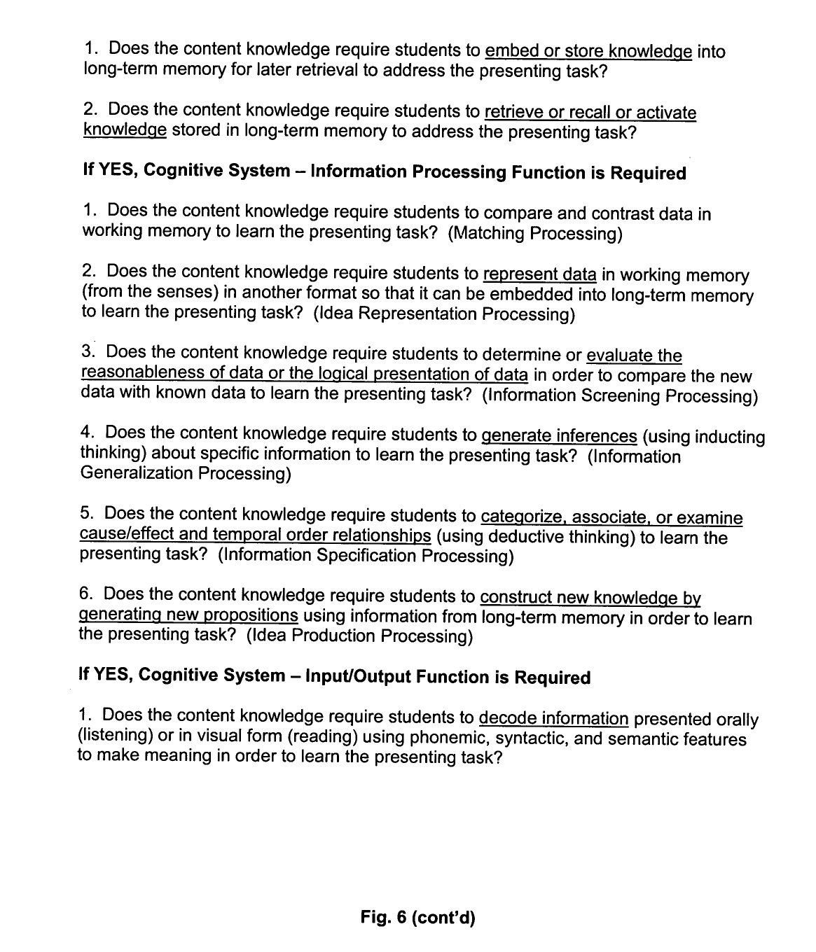

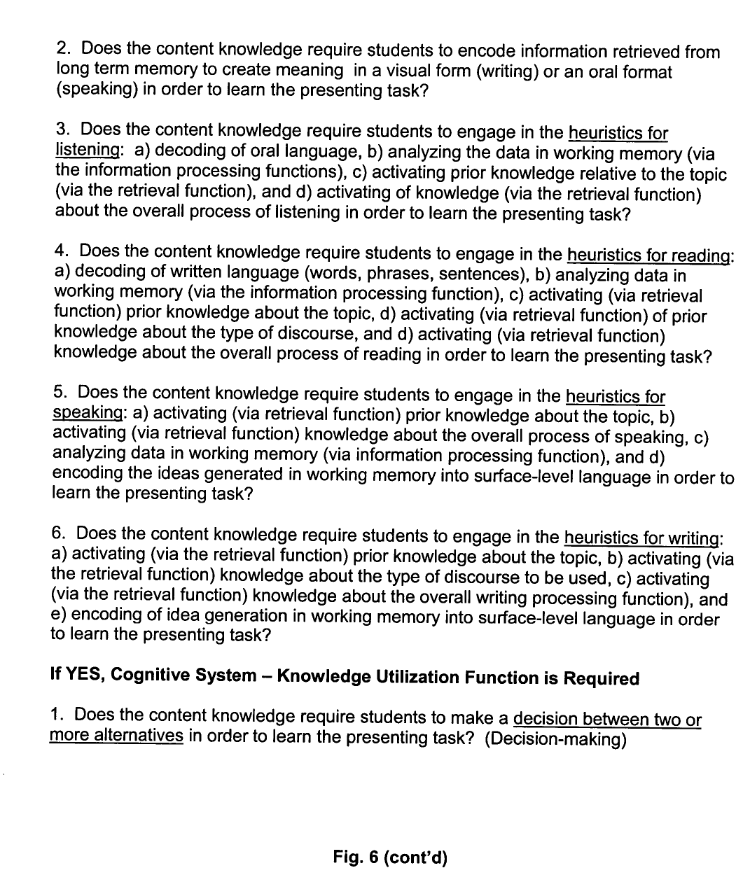

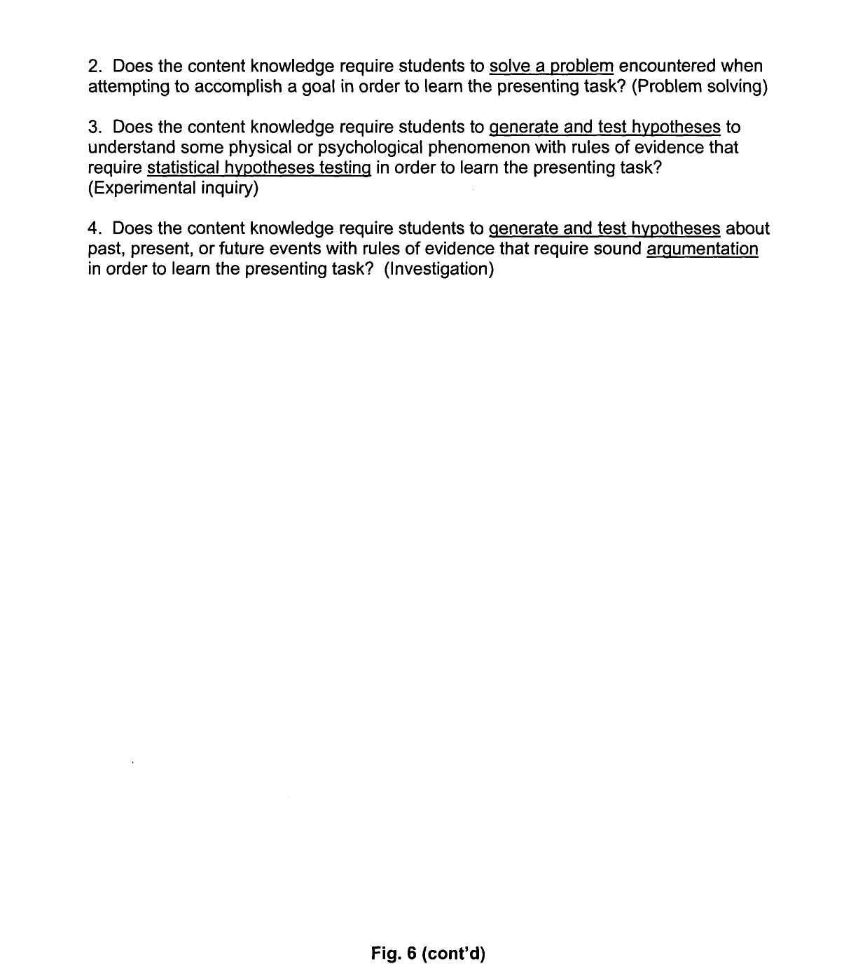

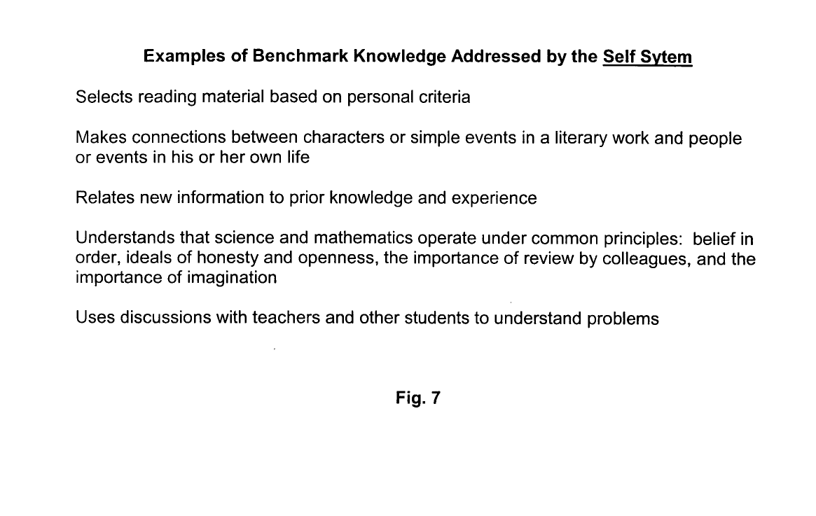

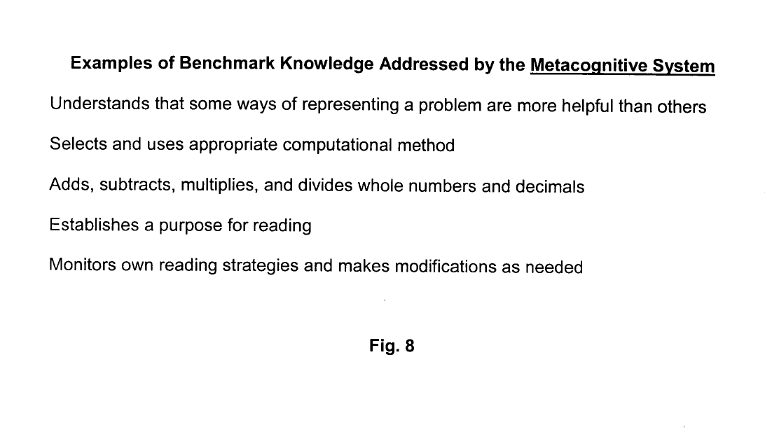

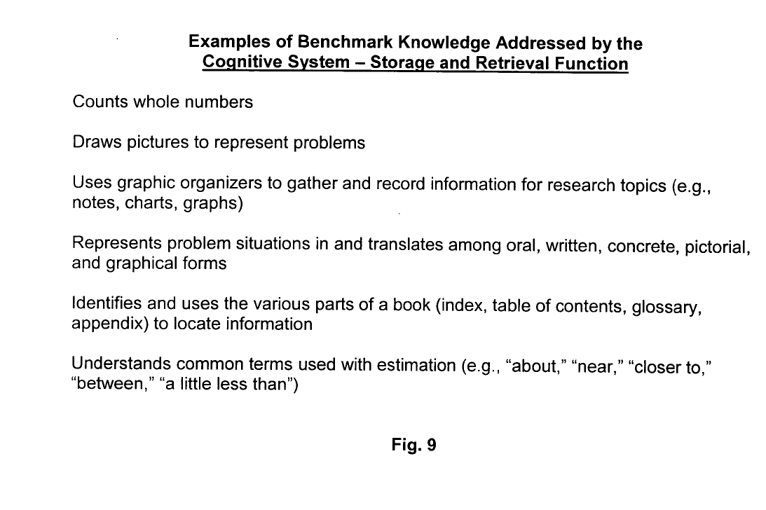

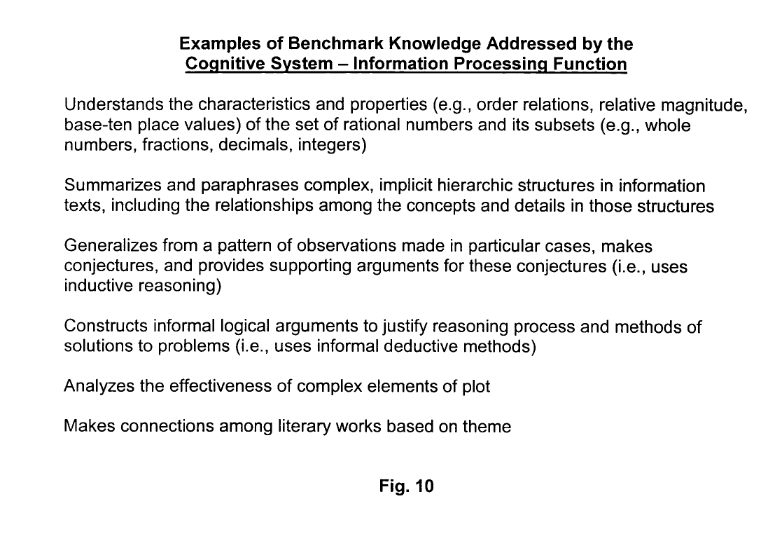

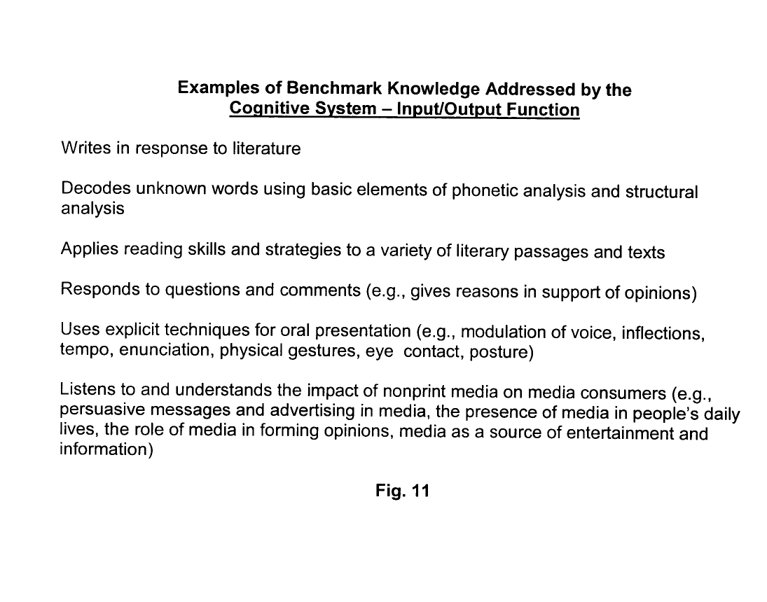

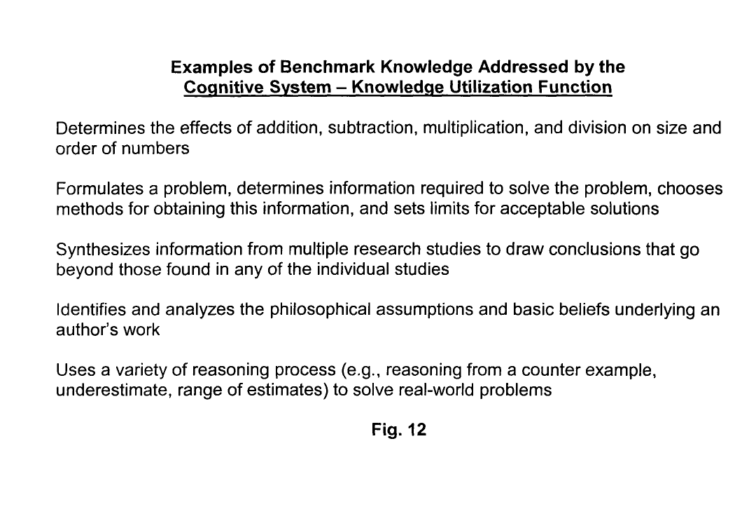

Classification of educational standards or benchmarks (content) into the proper systems of thinking may be accomplished systematically through a series of questions or tests directed at the content. FIG. 6 shows the classification test used by the inventor in connection with classifying the state instructional standards. FIGS. 7-12 depict state benchmark items that implicate the various systems of thinking utilizing the tests of content.

Alignment of Instruction to Content

Once the standards, benchmarks or other target content were classified, the available inventory of instructional strategies were mapped for conformance with the classification criteria. The qualities and characteristics of specific instructional strategies are known to education professionals, either through experience or through review of explanatory materials associated with the strategy details. Each instructional strategy is considered in the context of the content standard; the strategy is rejected unless it meets two criteria: a) the instructional strategy is designed to address critical attributes of declarative knowledge, procedural knowledge, or both, of the content, and b) the instructional strategy is designed to address the critical attributes of the brain processing required to learn the presenting task of content knowledge as stated in the standard.

The following example illustrates the benefit of using the alignment method described and claimed herein. The sample benchmark is one of the Level 3 (Grades 6-8) benchmarks of the McREL Language Arts Standard 7 (uses reading skills and strategies to understand and interpret a variety of informational texts).

### EXAMPLE 1

### Alignment According to Criteria

Content: Understand the organizational patterns of informational texts (e.g., chronological, logical, and sequential orders; compare and contrast; cause and effect; proposition and support)

Knowledge Domain: Declarative

1. It contains generalizations, principles, or overarching ideas requiring examples to support them.
2. It contains time sequences, cause/effect sequences, or episodes that students will need to remember and use.
3. It contains essential vocabulary terms and phrases that students need to practice
   Systems of Thinking and Processing Function(s) Required:

Information Processing
a. It requires students to compare and contrast data in working memory to learn the presenting task (Matching)
b. It requires students to categorize data to learn the presenting task (Information Specification)
c. It requires students to engage in the heuristics of reading to learn the presenting task. (Input/Output)

Storage and Retrieval
a. It requires students to retrieve or recall data stored in long term memory to learn the presenting task
b. It requires students to embed data into long-term memory.
   Instructional Strategies That Meet BOTH Criteria:

1. Pattern and Organization
Pattern and Organization is a strategy that allows students to identify the pattern or direction (Declarative Knowledge) that the author used through the use of visual organizers, discussion, and concrete examples, and is a key to improving reading comprehension.
It will enable learners to:
   Demonstrate their understanding of the organizational patterns for informational texts by comparing and contrasting various text patterns. (Cognitive System/Input/Output Function—Heuristics of Reading and Cognitive System/Information Processing Function —Matching)
   Provide concrete examples to indicate understanding of the attributes of informational texts (e.g., chronological, logical, and sequential order; compare and contrast; cause and effect; proposition and support) (Cognitive System/Information Processing Function/Information Specification)
   Draw a diagram to create a mental scheme for the text as a precursor to the learning of organizational patterns. (Cognitive System/Storage and Retrieval)
   Engage in discussions and predictions at various intervals in the text. (Metacognitive System/Process Monitoring)
   Build concrete examples of structure (e.g., pictures, physical actions, demonstrations) (Cognitive System/Storage and Retrieval)

2. Concept Attainment
Concept Attainment is a process for discovering the identifying characteristics and discriminating attributes of a concept, principle, generalization or idea (Declarative Knowledge), and for reflecting on how the learning occurred.
It will enable learners to:
   Learn the critical, distinguishing attributes of informational text patterns (e.g., chronological, logical, and sequential order; compare and contrast; cause and effect; proposition and support) (Cognitive System/Information Processing/Information Specification)
   Provide examples and non-examples of the concept to demonstrate understanding (Cognitive System/Information Processing/Matching)
   State the rule for inclusion/exclusion into each organizational pattern so that they can demonstrate their understanding of when an example fits the defining rules of that pattern, and when it does not. (Cognitive System/Information Processing/Information Generalization)
   Process how they learned the concepts, principles and generalizations in order to embed the new knowledge into long term memory by connecting it with prior knowledge. (Metacognitive System/Disposition Monitoring and Cognitive System/Storage and Retrieval)
      Rejected Instructional Strategies That Did Not Meet Criteria:
      1. Heuristics
Heuristics are the general rules, as opposed to a set of rigid steps, for processes (Procedural Knowledge) such as decision-making, experimental inquiry, reading, speaking, writing, problem solving, and investigation that students apply and practice with attention to how they might be improved.

It will enable learners to:
Identify similarities and differences, generate inferences about new knowledge, and use organizing ideas. (Cognitive System/Information Processing—Matching and Knowledge Utilization—Inquiry/Decision-Making)
Comprehend material presented in written or oral forms (reading, listening, speaking) Cognitive System/Input-Output and Storage/Retrieval and Metacognitive System/Process Specification/Process Monitoring/Disposition Monitoring)
Present information in written form. (Cognitive System/Input-Output and Storage/Retrieval and Metacognitive System/Process Specification/Process Monitoring/Disposition Monitoring)
Make decisions, solve problems, perform investigations, and to engage in experimental inquiry. (Cognitive System/Knowledge Utilization—Decision Making/Problem Solving/Inquiry/Investigation)
   Rejection Rationale:

Strategy addresses procedural knowledge; strategy has an emphasis on Knowledge Utilization processes not required in the content; strategy is dependent on the Metacognitive system for monitoring processes not required in the content.

2. Deductive Reasoning for Organizing Ideas

Deductive Reasoning for Organizing Ideas is reasoning from principles that, if true, guarantee that certain inferences must be true. (Procedural Knowledge) Used as a strategy for organizing ideas and thinking, it increases analysis, synthesis, and evaluation of concepts, principles, and generalizations inherent in academic content.

Deductive Reasoning for Organizing Ideas will enable learners to:
Provide examples of the concept of deduction, including what discriminates it from inductive thinking. (Cognitive System/Information Specification)
Apply the heuristics, or general guidelines, for deductive reasoning to making deductions from specified generalizations or principles (Cognitive System/Knowledge Utilization —Decision Making/Investigation and Metacognitive System/Process Specification/Process Monitoring)
Draw conclusions from premises (syllogism) and be able to justify their thinking. (Cognitive System/Information Processing—Information Screening/Information generalization/Idea Production and Knowledge Utilization—Investigation)
Use graphic organizers to record their thinking in peer groups. (Metacognitive System —Processing Monitoring and Cognitive System/Information Processing—Idea Representation and Storage/Retrieval)
Reflect on their reasoning with attention as to how it might be improved. (Metacognitive System/Process Monitoring/Disposition Monitoring)
   Rejection Rationale:

Strategy addresses procedural knowledge; strategy has a heavy emphasis on Knowledge Utilization processes not required in the content; strategy is dependent on the Metacognitive System for monitoring processes not required in the content; strategy requires significantly different functions of the Cognitive System.

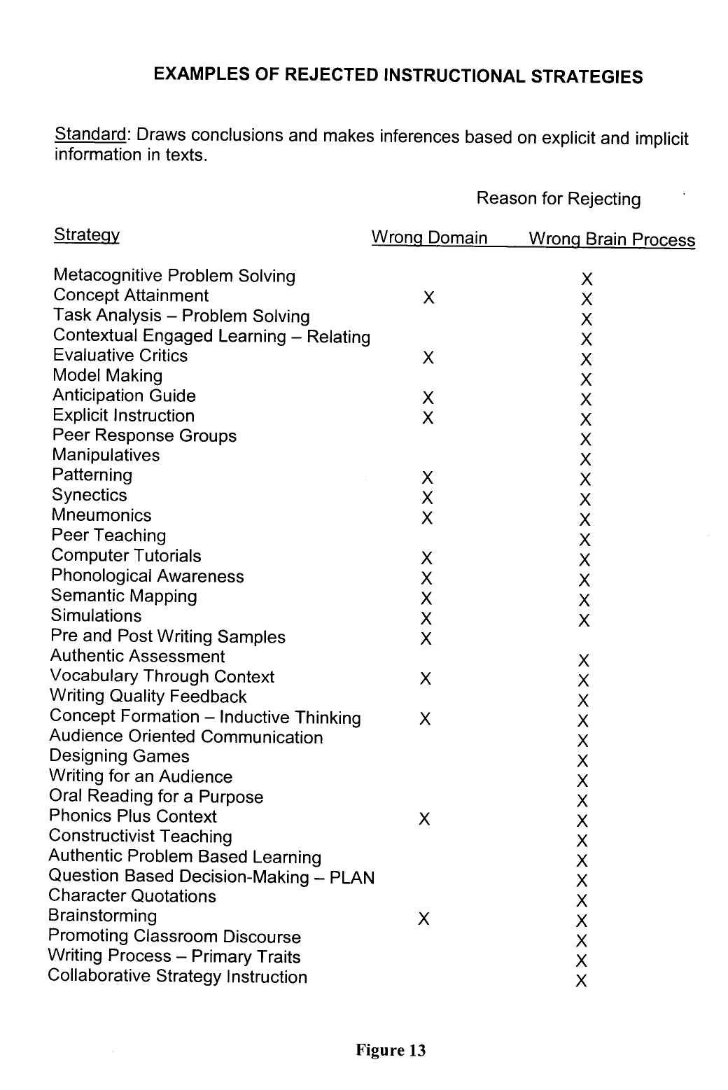

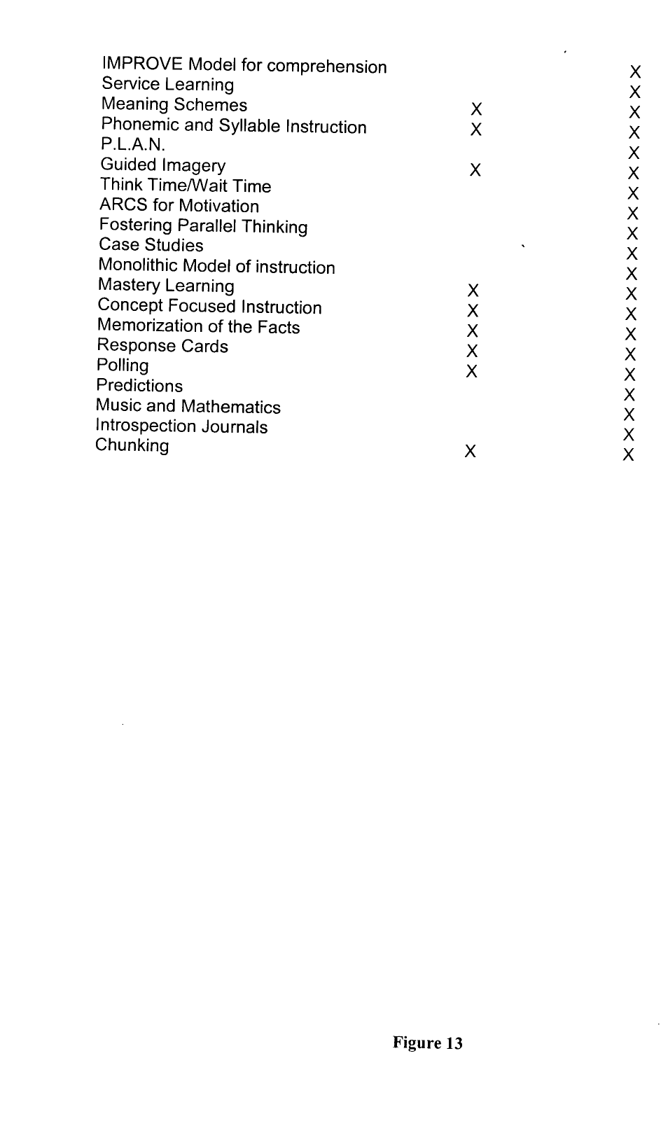

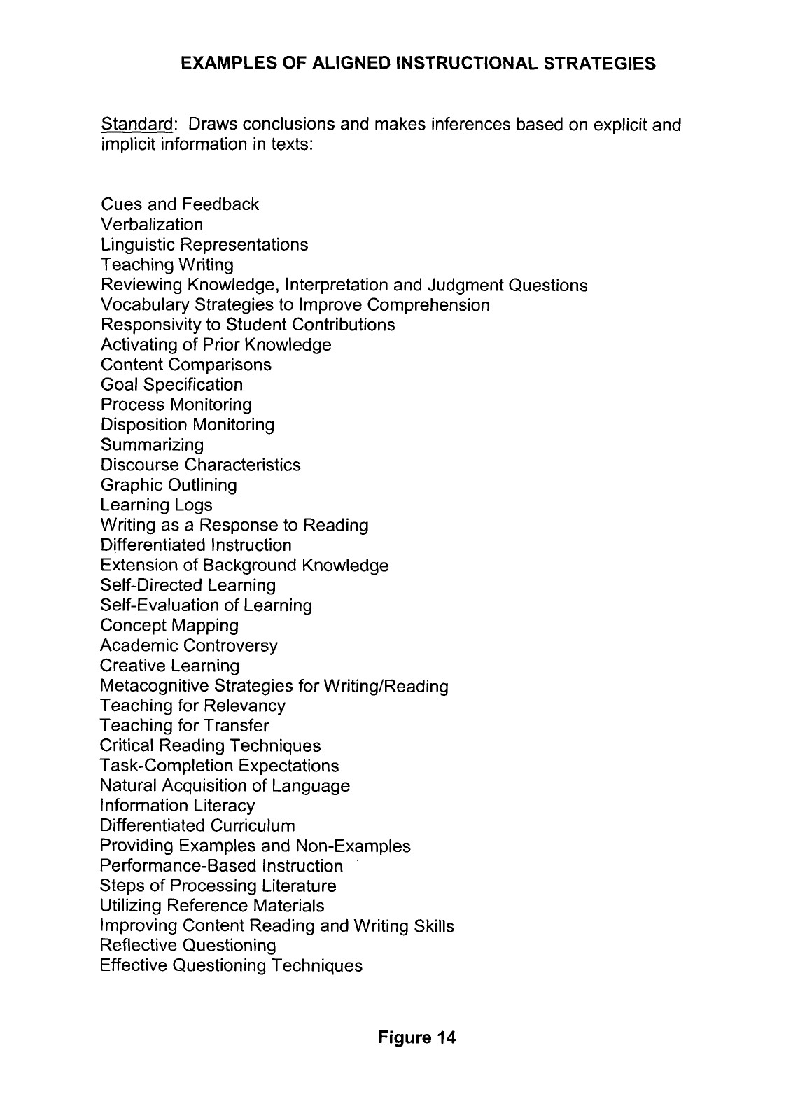

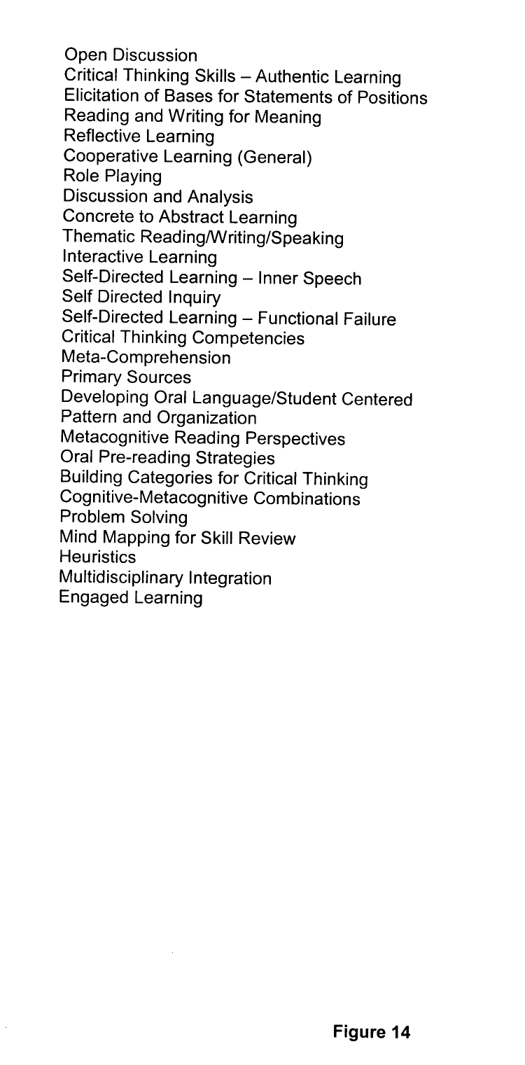

Various techniques may be utilized to improve the efficacy of the alignment step. In the project undertaken by the inventor, the alignment was conducted separately by content specialist and instruction specialist teams. Mapping by the first team was reviewed by the second team for rater agreement, and Items without 100% agreement were deleted. Agreed upon instructional strategies aligned to content were entered into the database. Because the inventory of available instructional strategies ran to many thousands of possibilities, the number of aligned strategies for a particular benchmark was often quite high. FIGS. 13 and 14 illustrate the results of application of the inventive method to a particular standard or benchmark, “draws conclusions and makes inferences based on explicit and implicit information in texts.” This is one of the six benchmarks for Level 3 (Grades 6-8) under Language Arts Standard 7 (Uses reading skills and strategies to understand and interpret a variety of informational texts) of the McREL Compendium. FIG. 13 shows the set of possible strategies rejected as inappropriate for addressing the benchmark and the reasons for rejection. FIG. 14 shows the strategies that do meet the criteria according to the inventive method. In this example, 70 strategies are candidates for adoption.

To enhance the usability of the aligned strategy database, two additional steps were taken to winnow down what, in many cases, was a list of dozens, if not hundreds, of aligned strategies for each benchmark. Because every strategy in the inventory carried an Effect Size from earlier research, a selection of the best 25 options was made based on a combination of the highest Effect Size and an evaluation of how well the strategy comprehensively addressed the identified content. In this phase, three independent teams made the evaluation, and their results were correlated. As a final step, the selected options were ranked using a pair-weighting process which employed a forced-choice format for choosing each instructional strategy against all others, creating a ranking of the instructional strategies. Other standard methodologies for winnowing and ranking the available aligned strategies may be employed, depending upon the size and nature of the strategy database

The foregoing description of the invention has been provided with reference to a particular embodiment. Persons of ordinary skill in the art will readily ascertain that variations are within the spirit and scope of the claims. For example, a particularized subset of educational strategies can be aligned to a group of standards for training required job skills in a specific industry or company.

### REFERENCES

Ajzen, I. & Fishbein, M. (1980). Understanding attitudes and predicting behavior. Englewood Cliffs, N.J.: Prentice Hall.
Ajzen, I. (1985). From intentions to actions: A theory of planned behavior. In J. Kuhl & J. Bechman (Eds.), Action-control: From cognition to behavior. Heidelberg, Springer.
Ajzen, I. and Fishbein, M. (1977). Attitude-behavior relations: A theoretical analysis and review of empirical research. Psychological Bulletin, 84, 888-918.
Ajzen, I., and Madden, T. J. (1986). Prediction of goal-directed behavior: Attitudes, intentions, and perceived behavioral control. Journal of Experimental Social Psychology, 22, 452-474.
Anderson, J. R. (1995). Learning and memory. An integrated approach. New York: John Wiley & Sons.
Caine, Geoffrey and Caine, Renate Nummela (1994). Mindshifts. Tucson, Ariz.: Zephyr Press.
Carlson, R. V., & Ducharme, E. R. (Eds.) (1987). School improvement—theory and practice: A book of readings. Lanham, M D: University Press of America.
Edmonds, Ronald (1982). “Programs of School Improvement: An Overview,” Educational Leadership, Vol 40, No. 3, December.
Flexner, S. B., and Hourck, L. C. (Eds.) (1987). The Random House Dictionary of the English Language (2nd edition unabridged). New York: Random House.
Garcia, T., & Pintrich, P. R. (1995). “The role of selves in adolescents' perceived competence and self-regulation.” Paper presented at the annual meeting of the American Educational Research Association, San Francisco, Calif.
Good, T. L. & Brophy, J. E. (1986) School Effects (Occasional Paper No 77). East Lansing, Mich.: Michigan State University, The Institute for Research on Teaching.
Greenfield, Susan (1997). The Human Brain: A guided tour. New York, N.Y.: Basic Books Perseus Books Group.
Jensen, Eric (1998). Teaching with the Brain in Mind, Alexandria, Va.: Association for Supervision and Curriculum Development.
Joyce, Bruce R. and Weil, Joyce (1996). Models of Teaching. Needham Heights, Mass.: Allyn & Bacon.
LeDoux, J. (1994). “Emotion, Memory & The Brain”. Scientific American. 170:6.
Lezotte, Lawrence W. (1987). “Effective Schools: What Works and Doesn't Work?” N.Y. Teacher: New York, N.Y.
Lindsay, P. H. & Norman, D. A. (1977). Human information processing. New York: Academic Press.
Marzano, R. J. & Kendall, John S. (1996). A Comprehensive Guide to Designing Standards-Based Districts, Schools, and Classrooms. Alexandria, Va.: ASCD.
Marzano, R. J. (1992). A Different Kind of Classroom: Teaching with Dimensions of Learning. Alexandria, Va.: ASCD.
Marzano, Robert (1998). A Theory-Based Meta-Analysis of Research on Instruction. Aurora, Colo.: McREL.
Purkey, Stewart C. and Smith, Marshall S., (1983). “Effective Schools: A Review,” The Elementary Journal. Vol. 83. No. 4, March.
Shank, R. C. and Abelson, R. (1977). Scripts, plans, goals and understanding. Hillsdale, N.J.: Erlbaum.
Slavin, Robert E. (1987). “Ability Grouping and Its Alternatives: Must We Track?” American Educator. Summer.
Snow, R. E., and Jackson, N. D. (1993). Assessment of conative constructs for educational research and evaluation: A catalog. (CSE Technical Report 354). Los Angeles: University of California, National Center for Research in Evaluation, Standards, and Student Testing (CRESST).
Snyder, Karolyn J. (1987). School Work Culture Profile. Sarasota, Fla.: University of South Florida.
Sprenger, Merilee (1999). Learning and Memory: The Brain in Action. Alexandria, Va.: ASCD.
Sternberg, R. J. (1986a). Inside intelligence. American Scientist, 74, 137-143.
Sternberg, R. J. (1986b). Intelligence applied. New York: Harcourt Brace Jovanovich, Publishers.
Stiggins, Richard (1994). Student Centered Classroom Assessment. New York, NUY: Merrill.
Sylwester, Robert (1995). A Celebration of Neurons: An Educator's Guide to the Brain. Alexandria, Va.: ASCD.
Taylor, Roger (1997). AHA! Analyzing Human Activities. Oak Brook Ill.: Curriculum Design for Excellence.
Wiggin, Grant (1997). “Curriculum Reform and Teaching for Understanding” Presented at Restructuring Curriculum-Assessment-Teaching for the 21^{st} Century. Scottsdale, Ariz.: NSCI
Wiggins, Grant, and Jay McTighe (1998). Understanding by Design. Alexandria, Va.: Association for Supervision and Curriculum Development.
Wolfe, Patrica (2001). Brain Matters: Translating Research into Classroom Practice. Alexandria, Va.: ASCD.

1. A method of aligning instructional strategies to knowledge to be learned, comprising the steps of identifying particular items of knowledge to be learned, classifying the items by knowledge domain implicated in each item, classifying the items by brain processing function used to learn each item, and selecting instructional strategies that address the knowledge domain and the brain processing function associated with each item.

2. The method of claim 1 further including the step of ranking the selected instructional strategies by an Effect Size associated with each selected instructional strategy.

3. The method of claim 1 further including the step of ranking the selected instructional strategies according to how well each strategy addresses the knowledge domain and brain processing function associated with each items of knowledge to be learned.

4. The method of claim 1 further including the step of ranking the selected instructional strategies using a combination of the Effect Size associated with each selected instructional strategy and a measure of how well each selected instructional strategy addresses the knowledge domain and brain processing function associated with each item of knowledge to be learned.
